(19) United States
(12) Patent Application Publication
(10) Pub. No.: US 2013/0282485 A1
(43) Pub. Date: Oct. 24, 2013

(54) Targeted Advertising Based on Client-Side Tracking

(71) Applicants: Fernando Barsoba, Durham, NC (US); David T. Britt, Greensboro, NC (US); Jason P. Hawrysz, Durham, NC (US)

(72) Inventors: Fernando Barsoba, Durham, NC (US); David T. Britt, Greensboro, NC (US); Jason P. Hawrysz, Durham, NC (US)

(73) Assignee: INTERNATIONAL BUSINESS MACHINES CORPORATION, Armonk, NY (US)

(21) Appl. No.: 13/449,815

(22) Filed: Apr. 18, 2012

(51) Int. Cl. G06Q 30/02

(52) U.S. Cl. 705/14.53

(57) ABSTRACT

Methods and systems may involve building a positive semantic network of advertising terms base on a web browsing activity of a user, and building a negative semantic of advertising terms based on one or more exclusion requests from the user. Additionally, the positive semantic network and the negative semantic network may be transmitted to a remote server while withholding information related to the identity of the user.

### BACKGROUND

Embodiments of the present invention generally relate to online advertising. More particularly, embodiments relate to client-side management of semantic networks for online advertising.

Conventional online advertising solutions may use small files and programs such as “cookies”, “Flash cookies” and “beacons” to track the web browsing activity of users, wherein the deployment of these techniques may lead to privacy concerns due to the potential release of sensitive information such as user identity. While recent “do not track” mechanisms may be under consideration as a privacy solution, there remains considerable room for improvement. For example, a do not track alternative may have a significant negative impact on the online advertising industry. Moreover, such an approach may limit the user to only generic advertising as well as reduce the amount of free online content.

### BRIEF SUMMARY

Embodiments may include a computer program product having a computer readable storage medium and computer usable code stored on the computer readable storage medium. If executed by a processor, the computer usable code may cause a local client device to build a positive semantic network of advertising terms based on a web browsing activity of a user, and build a negative semantic network of advertising terms based on one or more exclusion requests from the user. Additionally, the computer usable code can cause the local client device to transmit the positive semantic network and the negative semantic network to a remote server.

Embodiments may also include a computer implemented method of managing online advertising in which a positive semantic network of advertising terms is built on a local client device based on a web browsing activity of a user. The method can also provide for transmitting the positive semantic network to a remote server, and receiving one or more advertisements at the local client device, wherein at least one of the one or more advertisements correspond to the positive semantic network. In addition, a negative semantic network of advertising terms may be built based on one or more exclusion requests from the user, wherein at least one of the one or more exclusion requests are relative to at least one of the one or more advertisements. The method may also provide for transmitting the negative semantic network to the remote server, storing the positive semantic network and the negative semantic network on the local client device, and associating the positive semantic network and the negative semantic network with a profile of the user on the local client device. Moreover, an identity of the user may be withheld from the remote server.

Embodiments may also include a computer program product having a computer readable storage medium and computer usable code stored on the computer readable storage medium. If executed by a processor, the computer usable code may cause a local client device to build a positive semantic network of advertising terms based on a web browsing activity of a user on the local client device, and transmit the positive semantic network to a remote server. Additionally, the computer usable code can cause the local client device to receive one or more advertisements, wherein at least one of the one or more advertisements are to correspond to the positive semantic network. The computer usable code may also cause the local client device to build a negative semantic network of advertising terms based on one or more exclusion requests from the user, wherein at least one of the one or more exclusion requests are to be relative to at least one of the one or more advertisements. In addition, the computer usable code may cause the local client device to transmit the negative semantic network to the remote server, and store the positive semantic network and the negative semantic network on the local client device. Moreover, the computer usable code may cause the local client device to associate the positive semantic network and the negative semantic network with a profile of the user on the local client device, and withhold an identity of the user from the remote server.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1A is a block diagram of an example of a client-side online advertising architecture according to an embodiment;

FIG. 1B is a block diagram of an example of a server-side online advertising architecture according to an embodiment;

FIG. 2 is a flowchart of an example of a method of managing online advertising according to an embodiment; and

FIG. 3 is a block diagram of an example of a networking architecture according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

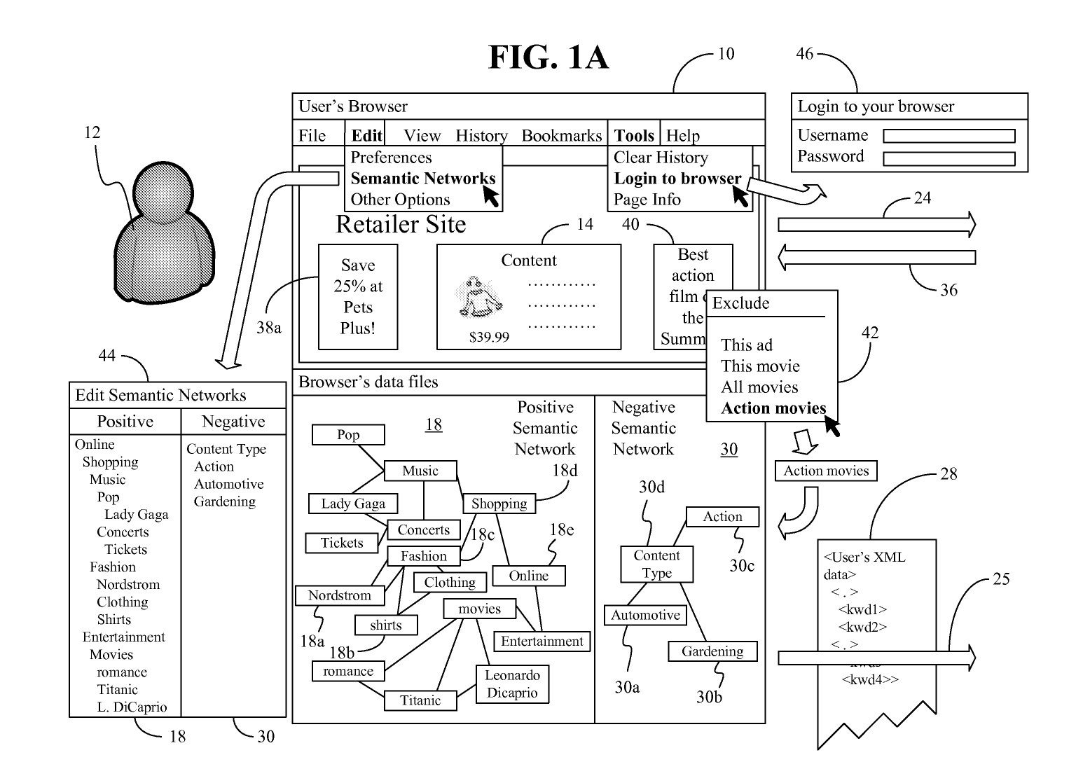

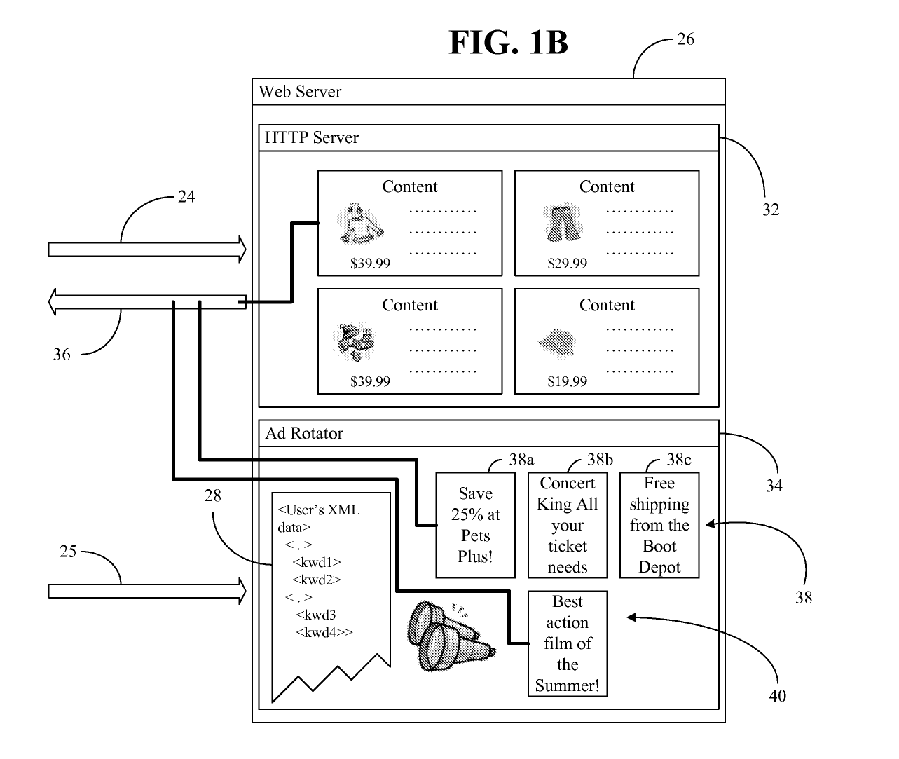

Referring now to FIG. 1A, a client-side browser 10 is shown, wherein a user 12 (“Alice”) may interact with the browser 10 in order to conduct online transactions and/or access online content such as web sites, pages, portals, and so forth. Example browsers include, but are not limited to, Firefox and/or Firefox Mobile from Mozilla, Internet Explorer and/or Internet Explorer for Mobile from Microsoft, other device-specific proprietary browsers (e.g., Apple iPhone web browser), etc. In the illustrated example, the user 12 navigates to an e-commerce (electronic commerce) site 16 of a retailer (e.g., “Nordstrom”) and selects content 14 such as a shirt description. This web browsing activity may result in the automatic creation and/or modification of a positive semantic network 18 (18a-18d) of advertising terms, wherein the positive semantic network 18 may generally reflect terms potentially of interest to the user 12. In the illustrated example, the positive semantic network 18 includes a retailer entry 18a that is linked either directly or indirectly with other related advertising terms such as, for example, a shirts entry 18b, a fashion entry 18c, a shopping entry 18d, an online entry 18, and so forth.

Thus, the illustrated approach represents an “automatic inclusion” solution that is managed by the browser 10 in order to minimize the amount of “non-browsing” input obtained from the user 12. Accordingly, the building of the positive semantic network 18 can have a minimal impact on the user's browsing experience. As the user 12 performs web searches, the browser 10 may interpret the user's search keywords and incorporate them into the positive semantic network 18. Additionally, as the illustrated user 12 interacts with a web page, the browser 10 may pull keywords/terms that are germane to the content of the web page and integrate those terms into the positive semantic network 18. Of particular note is that the illustrated terms that are integrated into the positive semantic network 18 are related strictly to content and contain no personal or otherwise identifying information with regard to the user 12.

For example, as the user 12 searches the web for a shirt, tickets, movies, etc., the browser may build the positive semantic network 18 from terms such as: “concerts”; a particular singer (e.g., “Lady Gaga”); “clothing”; a particular retailer (e.g., “Nordstrom”); “movies”; a particular movie (e.g., “Titanic”); a particular actor (e.g., “DiCaprio”), and so forth. The user's name (Alice), however, is never added to the positive semantic network 18, in the illustrated example. Accordingly, should the user 12 purchase an item from the retailer, the positive semantic network 18 may record nothing of the transaction, financial information, or credit information that may reflect the identity of the user 12. Thus, as the user's positive semantic network 18 continues to grow, it holds only information about the subjects in which she is interested, but nothing about the user 12 herself. Indeed, should the positive semantic network 18 be viewed out of context, the viewer would not be able to associate that semantic network 18 with the user 12, in the example shown.

With continuing reference to FIGS. 1A and 1B, the illustrated browser 10 generates one or more transmissions 24, 25 to a remote server 26, wherein the transmissions 24, 25 include instructions and/or data such as standard web protocol requests, and so forth, as well as an appropriate data structure 28 for communicating the positive semantic network 18 to the remote server 26. As will be discussed in greater detail, the data structure 28 may also include a negative semantic network 30 (30a-30c) that generally reflects advertising terms not of interest to the user 12. The particular format of the data structure 28 may be any format suitable for the browser 10 and or remote server 26. In one example, XML (extensible markup language) is used to create the data structure 28. Moreover, the positive semantic network 18 and the negative semantic network 30 may be stored to memory of the local client device on which the browser 10 executes.

The transmissions 24, 25 may therefore be used by an HTTP (hypertext transfer protocol) server 32 to select content, as well as by an ad rotator 34 to select advertisements (ads). With specific regard to the ad rotator 34, a parsing/analysis of the data structure 28 may be conducted to determine the advertising terms of the positive semantic network 18 and the negative semantic network 30. The ad rotator 34 may select a first set of advertisements 38 (38a-38c) that are in, comply with, or are otherwise related to, the positive semantic network 18. The ad rotator 34 may also select a second set of advertisements 40 that are outside, or otherwise not in conflict with the negative semantic network 30. If the negative semantic network 30 has not yet been created, the second set of advertisements 40 may selected from all advertisements available to the ad rotator 34. Although the second set of advertisements 40 includes a single ad in the example shown, the second set of advertisements 40 could include multiple ads. In the illustrated example, a responsive transmission 36 is generated based on the content selected by the HTTP server 32 and the ads selected by the ad rotator 34.

Ads from the first set of advertisements 38 such as the advertisement 38a, and ads from the second set of advertisements 40 may be displayed alongside the content 14 in the browser 10, wherein the user 12 can be provided with an exclude menu 42 (e.g., right click listing of options) for the ads displayed in the browser 10. The illustrated exclude menu 42 enables the user 12 to actively prevent particular ads and/or ads of a certain type from being displayed in the browser 10. In this regard, since the illustrated ad rotator 34 is free to select any available ads that are outside the negative semantic network 30 (which may not even exist in the early stages of network building), it may be possible that the user 12 can receive an advertisement for which she has no interest. Accordingly, the illustrated “active exclusion” solution enables the user 12 to build the negative semantic network 30 while browsing.

For example, Alice has not browsed any web pages related to the genre of action movies, but she has also not explicitly indicated that she has no interest in this type of content. As Alice is shopping on the retailer's web site, an advertisement 40 for an action movie has been delivered to her by the web server 26. Deciding that she does not wish to receive information about this type of content, she right clicks on the advertisement, and is presented with the menu 42 that gives an option to exclude that specific advertisement, content relating to that specific movie, content relating to action movies, or content relating to all movies. She selects the option to exclude content related to action movies, and the appropriate keywords/terms related to the action genre are added to her negative semantic network 30. As a result, Alice will no longer receive ads for action movies while browsing, in the example shown.

The illustrated example also includes a network editor interface 44 that enables the user 12 to pro-actively include and exclude terms from the positive semantic network 18 as well as the negative semantic network 30. In particular, one or more inclusion entries/requests may be received from the user 12 via the network editor interface 44, wherein the positive semantic network 18 can be built based on the inclusion requests. Similarly, one or more exclusion entries/requests may be received from the user 12 via the network editor interface 44, wherein the negative semantic network 30 can be built based on the exclusion requests. Thus, the exclusion requests received via the network editor interface 44 may be in addition to the exclusion requests received via the exclude menu 42. Terms may also be removed from either of the semantic networks 18, 30 via the network editor interface 44.

For example, Alice may have no interest in subjects with automotive or gardening content. Using the interface 44, she can open her semantic networks 18, 30 and manually enter the terms “automotive” and “gardening” into her negative semantic network 30. Similarly, while browsing for concert tickets for a particular singer (e.g., Lady Gaga), she could accidentally click on a web page containing content that Alice finds distasteful. Though she may close out of that web page, terms for the content might have already been added to her positive semantic network 18 (e.g., via the automatic inclusion solution, already discussed). To prevent this subject from remaining in her network of interests, she opens the interface 44, locates the distasteful terms in the positive semantic network 18, and deletes them.

The illustrated example also includes a profile login interface 46 that enables the user 12 to associate the semantic networks 18, 30 with a profile dedicated to the user 12 in question and stored locally on memory of the client device. In this regard, it may not be uncommon for multiple users to share the same computer. The illustrated profile login interface 46 may therefore enable the user's browsing habits to be prevented from affecting the interests recorded automatically for another user. In particular, the user 12 can enter a user identity or user ID/password combination to identify the user 12 to the browser 10. In doing so, the browser 10 may then create a distinct semantic network pair for only that user 12.

For example, consider a scenario in which Alice has actively excluded the action movie genre from her browsing experience on a computer that she shares with a younger relative who enjoys watching action movies. The younger relative may be aware that his interests differ from those of Alice, and might create his own user profile on the shared computer's browser 10. Upon accessing the computer, he may utilize the interface 46 to identify himself to the browser 10, wherein the login process instructs the browser 10 to use the semantic network pair that has been maintained specifically for this younger relative. Because the younger relative's profile has been unaffected by Alice's web browsing, as he begins browsing the Internet, he now frequently sees advertisements for upcoming action movies in which he may be interested in seeing.

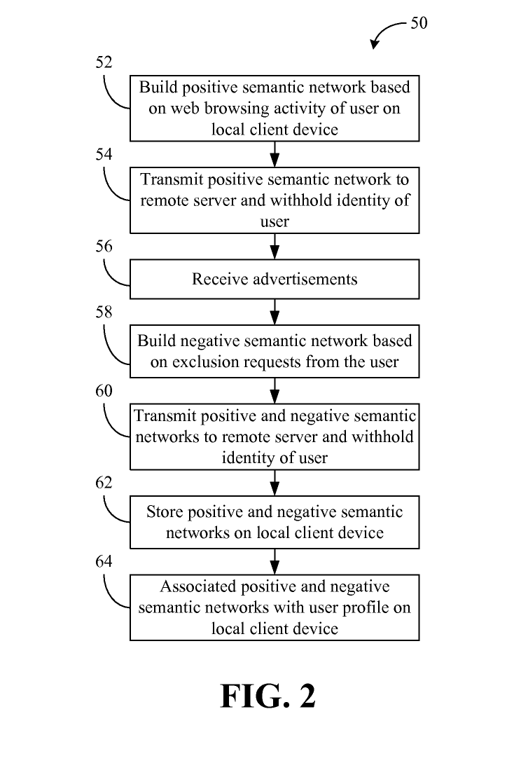

Turning now to FIG. 2, a method 50 of managing online advertising is shown. Illustrated processing block 52 provides for building a positive semantic network of advertising terms based on the web browsing activity of a user on a local client device, wherein the positive semantic network may be transmitted to a remote server at block 54. Information related to the identity of the user may also be withheld at block 54. One or more advertisements may be received at block 56, wherein at least one of the received advertisements corresponds to the positive semantic network. In addition, illustrated block 58 builds a negative semantic network based on one or more exclusion requests from the user. In one example, at least one of the exclusion requests is relative to an advertisement received at block 56. A positive and negative semantic network pairing may be transmitted to the remote server at block 60, wherein the identity of the user can withheld once again. Illustrated block 62 also provides for storing the positive and negative semantic networks on the local client device. Additionally, the positive and negative semantic networks may be associated with a user profile on the local client device at block 64.

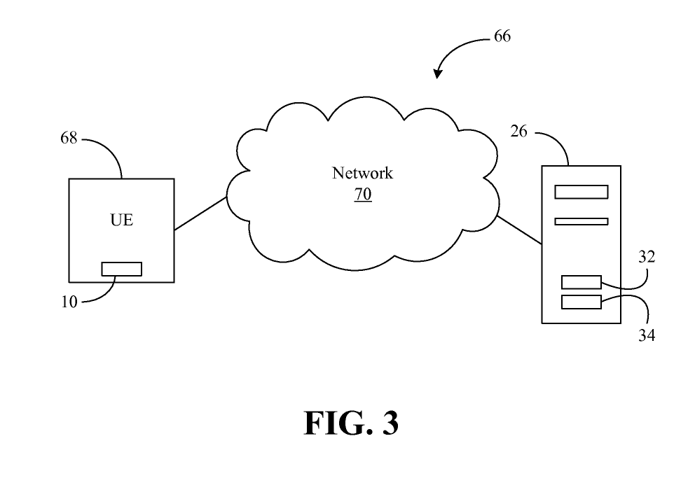

FIG. 3 shows a networking architecture 66 in which a user equipment (UE) device 68 includes a browser 10, and a web server 26 includes an HTTP server 32 and an ad rotator 34, as already discussed. In the illustrated example, the server 26 is configured to provide web content and advertisements to the UE device 68 via a network 70, wherein the advertisements are targeted/tailored to the web browsing activity and preferences of a user without the web server 26 having access to the identity of the user. The network 70 can itself include any suitable combination of servers, access points, routers, base stations, mobile switching centers, public switching telephone network (PSTN) components, etc., to facilitate communication between the UE device 68 and the server 26. Techniques described herein may therefore protect the user's privacy while still providing to advertisers the benefits of targeted advertising.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
building a positive semantic network of advertising terms based on a web browsing activity of a user on a local client device;
transmitting the positive semantic network to a remote server;
receiving one or more advertisements at the local client device, wherein at least one of the one or more advertisements correspond to the positive semantic network;
building a negative semantic network of advertising terms based on one or more exclusion requests from the user, wherein at least one of the one or more exclusion requests are relative to at least one of the one or more advertisements;
transmitting the negative semantic network to the remote server;
storing the positive semantic network and the negative semantic network on the local client device;
associating the positive semantic network and the negative semantic network with a profile of the user on the local client device; and
withholding an identity of the user from the remote server.

2. The method of claim 1, wherein the positive semantic network reflects terms potentially of interest to the user.

3. The method of claim 1, wherein the negative semantic network reflects terms not of interest to the user.

4. The method of claim 1, further including:
receiving one or more inclusion requests from the user via a network editor interface, wherein the positive semantic network is built further based on the one or more inclusion requests; and
receiving one or more additional exclusion requests from the user via the network editor interface, wherein the negative semantic network is built further based on the one or more additional exclusion requests.

5. The method of claim 1, wherein the web browsing activity includes one or more of web page accesses and online transactions.

6. A computer program product comprising:
a computer readable storage medium; and
computer usable code stored on the computer readable storage medium, wherein if executed by a processor, the computer usable code causes a local client device to:
build a positive semantic network of advertising terms based on a web browsing activity of a user;
transmit the positive semantic network to a remote server;
receive one or more advertisements, wherein at least one of the one or more advertisements are to correspond to the positive semantic network;
build a negative semantic network of advertising terms based on one or more exclusion requests from the user, wherein at least one of the one or more exclusion requests are to be relative to at least one of the one or more advertisements;
transmit the negative semantic network to the remote server;
store the positive semantic network and the negative semantic network on the local client device;
associate the positive semantic network and the negative semantic network with a profile of the user on the local client device; and
withhold an identity of the user from the remote server.

7. The computer program product of claim 6, wherein the positive semantic network is to reflect terms potentially of interest to the user.

8. The computer program product of claim 6, wherein the negative semantic network is to reflect terms not of interest to the user.

9. The computer program product of claim 6, wherein the computer usable code, if executed, causes the local client device to:
receive one or more inclusion requests from the user via a network editor interface, wherein the positive semantic network is to be built further based on the one or more inclusion requests; and
receive one or more additional exclusion requests from the user via the network editor interface, wherein the negative semantic network is to be built further based on the one or more additional exclusion requests.

10. The computer program product of claim 6, wherein the web browsing activity is to include one or more of web page accesses and online transactions.

11. A computer program product comprising:
a computer readable storage medium; and
computer usable code stored on the computer readable storage medium, wherein if executed by a processor, the computer usable code causes a local client device to:
build a positive semantic network of advertising terms based on a web browsing activity of a user;
build a negative semantic network of advertising terms based on one or more exclusion requests from the user; and
transmit the positive semantic network and the negative semantic network to a remote server.

12. The computer program product of claim 11, wherein the computer usable code, if executed, causes the local client device to receive one or more advertisements, wherein at least one of the one or more advertisements are to correspond to the positive semantic network.

13. The computer program product of claim 12, wherein at least one of the one or more exclusion requests are to be relative to at least one of the one or more advertisements.

14. The computer program product of claim 11, wherein the computer usable code, if executed, causes the local client device to withhold an identity of the user from the remote server.

15. The computer program product of claim 11, wherein the computer usable code, if executed, causes the local client device to store the positive semantic network and the negative semantic network on the local client device.

16. The computer program product of claim 15, wherein the computer usable code, if executed, causes the local client device to associate the positive semantic network and the negative semantic network with a profile of the user on the local client device.

17. The computer program product of claim 11, wherein the positive semantic network is to reflect terms potentially of interest to the user.

18. The computer program product of claim 11, wherein the negative semantic network is to reflect terms not of interest to the user.

19. The computer program product of claim 11, wherein the computer usable code, if executed, causes the local client device to:
receive one or more inclusion requests from the user via a network editor interface, wherein the positive semantic network is to be built further based on the one or more inclusion requests; and
receive one or more additional exclusion requests from the user via the network editor interface, wherein the negative semantic network is to be built further based on the one or more additional exclusion requests.

20. The computer program product of claim 11, wherein the web browsing activity is to include one or more of web page accesses and online transactions.
